(19) United States
(12) Patent Application Publication
(10) Pub. No.: US 2007/0270515 A1
(43) Pub. Date: Nov. 22, 2007

(54) TOUGHENED POLYMERIC MATERIAL AND METHOD OF FORMING AND USING SAME

(75) Inventors: Craig Chmielewski, Shelby Twp., MI (US); Christopher Hable, Romeo, MI (US)

Correspondence Address: DOBRUSIN & THENNISCH PC, 29 W LAWRENCE ST, SUITE 210, PONTIAC, MI, 48342, US

(73) Assignee: Zephyros, Inc.

(21) Appl. No.: 11/747,622

(22) Filed: May 11, 2007

Related U.S. Application Data
(60) Provisional application No. 60/747,677, filed on May 19, 2006.
(60) Provisional application No. 60/862,113, filed on Oct. 19, 2006.

(51) Int. Cl. C08G 61/04; B32B 3/26

(52) U.S. Cl. 520/1; 428/304.4

(57) ABSTRACT

A polymeric material (e.g., a thermoplastic material) is modified to provide desirable properties to the material.

### CLAIM OF PRIORITY

This application claims the benefit of the filing dates of U.S. Provisional Application Nos. 60/747,677 filed May 19, 2006 and 60/862,113 filed Oct. 19, 2006.

### FIELD OF THE INVENTION

The present invention relates to a toughened polymeric material and a method of forming and using the material. More particularly, the present invention relates to a toughened thermoplastic material, a method of forming, toughening and or using that toughened thermoplastic material.

### BACKGROUND OF THE INVENTION

For many years, industry has been developing various different polymeric materials such as plastics, thermoplastics, elastomers and the like. Depending upon the intended use of the polymeric materials, it is often desirable for these polymeric materials to exhibit one or more desirable properties such as strength, toughness, endurance, combinations thereof or the like. The present invention seeks to provide a new polymeric material that exhibits one or more of such desirable properties. Moreover, the present invention seeks to provide a method of forming and and/or using the new polymeric material.

### SUMMARY OF THE INVENTION

According there is disclosed a toughened polymeric material. The toughened polymeric material typically includes a thermoplastic material and at least one toughener. The thermoplastic material, in a particularly desirable embodiment, is comprised of polymeric chains and includes a polyetheramine. The at least one toughener is typically a tougher thermoplastic polymer, an elastomer or a combination thereof. The at least one toughener can be grafted onto ends of the polymeric chains. The at least one toughener can be disposed along the polymeric chains as pendant group or within the polymeric chains. The at least one toughener can also be non-reactively blended with the polymer chains.

### DETAILED DESCRIPTION

The present invention is predicated upon the provision of a new polymeric material. As discussed herein, the polymeric material is most frequently referred to as a thermoplastic material, but it should be understood that it may also be possible to use the techniques disclosed herein or other techniques to form the polymeric material in a alternative form such as a thermoset or thermosettable material. Generally it is desirable for the thermoplastic material of the present invention to exhibit desirable properties such as strength or toughness due to the manner in which the thermoplastic material has been processed and/or due to the material added or chemical makeup of the thermoplastic material. In one particularly preferred embodiment, the thermoplastic material is modified (e.g., toughened) through the addition or integration of one or more elastomers (e.g., rubbers) or other polymers to or within the thermoplastic material. It is generally contemplated that the one or more elastomers can be non-reactively compounded with the thermoplastic material, however, it is preferred for the one or more elastomers to be chemically reactive or functional with the thermoplastic material such that the one or more elastomers chemically react and integrate with the thermoplastic material.

Generally speaking, the thermoplastic material is a chain of repeat units. This repeating chain may be linear as shown below as a chain of Ts wherein T is the repeat unit where x is typically greater than 1000:

-(T-T-T-T-T-T-T)ₓ-

Or the repeating structure may have some branching such as:

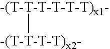

where x1 is again typically greater than 1000. When X1>X2 and 1<x2<10, x2 is considered a short chain branch and the thermoplastic is considered to contain short chain branches. When X2>10, then the thermoplastic is considered long chain branched or to have long chain branching. Other molecular configurations of the thermoplastic are also possible such as, but not limited to, multiple short or long chain branching along a primary linear chain (so called comb configuration) or star branches.

As such, the one or more elastomers may be randomly integrated into the thermoplastic chain as shown below:

-(T-E-T-T-T-E-T-T-T-E-T)ₓ-

wherein the letter E represents the one or more elastomers. When E represents an elastomer (e.g., a single elastomer), such a thermoplastic is known as a random block-copolymer. It is also contemplated that one or more elastomers may be grouped in to blocks relative to the thermoplastic chain as shown below:

(E-E-E-E-E-)ₓ₁-(T-T-T-T-T-T)ₓ₂-

When E represents an elastomer (e.g., a single elastomer), such a thermoplastic is typically known as an A-B block co-polymer or a di-block copolymer. Following this reasoning, when an additional polymer block is added the resulting polymers may become an A-B-A co-polymer of an A-B-C triblock polymer when two chemically distinct polymer blocks are present or three chemically distinct polymer blocks respectively.

It is further contemplated that the one or more elastomers may be pendant relative to the thermoplastic chain as shown below:

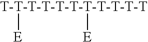

When E represents an elastomer (e.g., a single elastomer), such a thermoplastic is typically known as a graft co-polymer.

The one or more elastomers may also be an end group for one or more thermoplastic chains as show below:

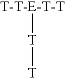

Generally, formation of the modified thermoplastic material includes formation or provision of a thermoplastic material and addition of one or more elastomers to that thermoplastic material. As used herein, the term thermoplastic material can include a thermoplastic material, precursors or reactants that can react to form the thermoplastic material or a combination thereof. Moreover, it should be understood that addition of the one or more elastomers to the thermoplastic material can include addition of the one or more elastomers to a first precursor of the thermoplastic material following by mixing of a second precursor of the thermoplastic material with the first precursor and the one or more elastomers. Preferably, the one or more elastomers can provide the modified thermoplastic material with one or more desirable properties such as enhanced toughness.

Thermoplastic Material

It is contemplated that multiple different thermoplastic materials may be employed in the present invention. Suitable thermoplastics include, without limitation, thermoplastic epoxy resins, amine/epoxy resins, hydroxyl containing epoxy resins, combinations thereof or the like.

In one embodiment, the thermoplastic material is a compound that includes at least one epoxy group and at least one amine group. Examples of such materials are poly(hydroxy ethers) or polyetheramines and more particularly, thermoplastic hydroxyl-functionalized polyetheramines (e.g., polyhydroxy amino ethers (PHAE)), which are particularly suitable as thermoplastics for the present invention and which can also be referred to as thermoplastic epoxy resins (TPERs). These polyetheramines are typically formed through the reaction of one or more polyfunctional and preferably difunctional amines with one or more polyfunctional and preferably difunctional epoxy resins for forming a primarily (i.e., at least 70, 80, 90 % or more) linear hydroxyl-functionalized polyetheramine resin. Advantageously, the molecular weight of the polyetheramine resin can be modified by varying the reactant ratios of amine to epoxy.

One exemplary polyetheramine suitable for use in the present invention has repeating units represented by the formula:

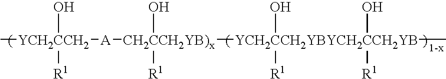

wherein each A is individually a divalent amine moiety; each B is individually a divalent aromatic moiety; each Y is divalent oxygen or sulfur, R¹ is hydrogen or a monovalent hydrocarbon and x is a number sufficient to reduce the oxygen permeability of the polyether to a value which is measurably lower than that of a polyether consisting of repeating units represented by the formula:

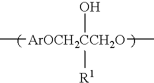

wherein Ar is the divalent radical resulting from the removal of two hydroxyl moieties from bisphenol A.

Another suitable polyetheramine is represented by the structural formula:

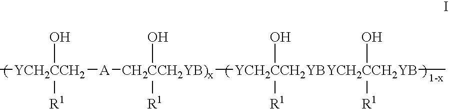

wherein B, R¹, Y and x are as previously defined, and each A is individually an amine moiety represented by the formula:

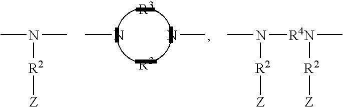

in which R² is C₂-C₁₀ hydrocarbylene; R³ is a C₂-C₁₀ alkylene; R⁴ is a C₂-C₂₀ hydrocarbylene; Z is alkylamido, hydroxy, alkoxy, alkylcarbonyl, aryloxy, arylcarbonyl, halo, or cyano.

For purposes of this invention, “hydrocarbyl” is a monovalent hydrocarbon such as alkyl, cycloalkyl, aralkyl, or aryl and “hydrocarbylenell is a divalent hydrocarbon such as alkylene, cycloalkylene, aralkylene or arylene.

In a further aspect, this invention is a reactive extrusion process for preparing the hydroxy-functional polyetheramine which comprises contacting a diglycidyl ether of a dihydric phenol with an amine having only two hydrogens under conditions sufficient to form the polyetheramine.

In preferred embodiments of the invention, each A of the polyetheramines represented by Formula I is individually represented by one of the formulas:

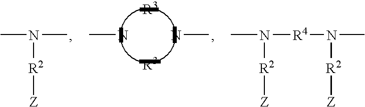

in which R² is C₂-C₁₀ alkylene or phenylene, with ethylene being most preferred; R³ is C₂-C₁₀ alkylene or substituted C₂-C₁₀ alkylene wherein the substituent(s) is alkylamido, hydroxy, alkoxy, halo, cyano, aryloxy, alkylcarbonyl or arylcarbonyl, with ethylene being most preferred; R⁴ C₂-C₂₀ alkylene or substituted C₂-C₂₀ alkylene wherein the substituent(s) is alkylamido, hydroxy, alkoxy, halo, cyano, aryloxy, alkylcarbonyl or arylcarbonyl, with ethylene and p-xylylene being most preferred; Z is alkylamido, hydroxy, alkoxy, halo, aryloxy, cyano, alkylcarbonyl or arylcarbonyl, with alkylamido, hydroxy and alkoxy being most preferred. Each B is individually carbonyldiphenylene, m-phenylene, p-phenylene, sulfonyldiphenylene, isopropylidenediphenylene, biphenylene, biphenylene oxide, methylenediphenylene, biphenylene sulfide, naphthylene, biphenylenecyanomethane, 3,3′-dialkyldiphenyleneisopropylidene, 3,3′,4,4′-tetraalkyldiphenyleneisopropylidene and the corresponding alkyl-substituted derivatives of the other named divalent aromatic moieties wherein the substituent(s) is a monovalent moiety which is inert in the reactions used to prepare the polyetheramine. More preferably, A is represented by the formulas:

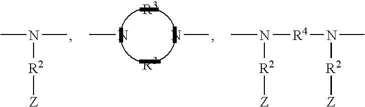

wherein each R² is individually a C₂-C₅ alkylene such as ethylene, propylene, butylene or pentylene; R³ is a C₂-C₅ alkylene such as ethylene, propylene, butylene or pentylene; R⁴ is a C₂-C₁₀ alkylene such as ethylene, propylene, butylene or pentylene, or arylene such as phenylene or xylylene; Z is alkylamido, hydroxy or alkoxy; B is isopropylidenediphenylene or phenylene; R¹ is hydrogen or methyl and x is in the range from about 0.5 to 1.0. The polyetheramines are most preferably those represented by the formula:

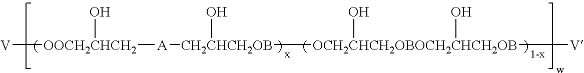

wherein A, B and x are as defined above, w is a number from 10 to 400 and each V and VI is individually a secondary amine such as

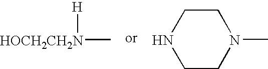

or a tertiary amine such as

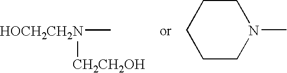

The polyetheramines employed in this invention are suitably prepared by contacting one or more of the diglycidyl ethers of a dihydric phenol with an amine having two amine hydrogens and represented by AH₂ wherein A is as previously defined under conditions sufficient to cause the amine moieties to react with epoxy moieties to form a polymer backbone having amine linkages, ether linkages and pendant hydroxyl moieties. Conditions conventionally employed in the reaction of diglycidyl ethers with amines to form amine linkages and pendant hydroxyl groups are suitably employed in preparing the resins of this invention. Examples of such suitable conditions are set forth in U.S. Pat. No. 3,317,471, which is hereby incorporated by reference in its entirety. In most case, but not all, the process for preparing the polymers including the copolymers is carried out so that the unreacted epoxy groups in the finished polyether are minimized. However, it is possible to have unreacted epoxy groups and still substantially process the material as a thermoplastic as will be further understood according to examples provided below.

In the preparation of copolymers (i.e., where x in the aforementioned formulae is less than one), a dihydric phenol is employed in addition to the amine. In such copolymerizations, while it is possible to subject a mixture of the diglycidyl ether(s), amine(s) and dihydric phenol(s) to copolymerization conditions, it is sometimes desirable to employ a staged addition procedure wherein the dihydric phenol is added before the amine is introduced or after essentially all of the amine has reacted with the diglycidyl ether. In the preparation of the copolymers wherein the reaction of dihydric phenol with diglycidyl ether is desired, conditions are employed to promote such reactions such as described in U.S. Pat. No. 4,647,648, which is hereby incorporated by reference in its entirety.

The diglycidyl ethers of the dihydric phenols are preferably the diglycidyl ethers of resorcinol, hydroquinone, 4,4′-isopropylidene bisphenol (bisphenol A), 4,4′-dihydroxydiphenylethylmethane, 3,3′-dihydroxydiphenyldiethylmethane, 3,4′-dihydroxydiphenylmethylpropylmethane, 4,4′-dihydroxydiphenyloxide, 4,4′-dihydroxydiphenylcyanomethane, 4,4′-dihydroxybiphenyl, 4,4′-dihydroxybenzophenone (bisphenol-K), 4,4′-dihydroxydiphenyl sulfide, 4,4′-dihydroxydiphenyl sulfone, 2,6-dihydroxynaphthalene, 1,4′-dihydroxy-naphthalene, catechol, 2,2-bis(4-hydroxyphenyl)-acetamide, 2,2-bis(4-hydroxyphenyl)ethanol, 2,2-bis(4-hydroxyphenyl)-N-methylacetamide, 2,2-bis(4-hydroxy-phenyl)-N,N-dimethylacetamide, 3,5-dihydroxyphenyl-acetamide, 2,4-dihydroxyphenyl-N-(hydroxyethyl)-acetamide, and other dihydric phenols listed in U.S. Pat. Nos. 3,395,118, 4,438,254 and 4,480,082 which are hereby incorporated by reference as well as mixtures of one or more of such diglycidyl ethers. Of these preferred diglycidyl ethers, those of bisphenol-A, hydroquinone, and resorcinol are more preferred, with the diglycidyl ether of bisphenol-A being most preferred.

Examples of preferred amines include piperazine and substituted piperazines, e.g., 2-(methylamido)piperazine and dimethylpiperazine; aniline and substituted anilines, e.g., 4-(methylamido)aniline, 4-methoxyaniline, 4-tert-butylaniline, 3,4-dimethoxyaniline and 3,4-dimethylaniline; alkyl amines and substituted alkyl amines, e.g., butylamine and benzylamine; alkanol amines, e.g., 2-aminoethanol and 1-aminopropan-2-ol; and aromatic and aliphatic secondary diamines, e.g., 1,4-bis(methylamino)benzene, 1,2-bis(methylamino)ethane and N,N′-bis(2-hydroxyethyl)ethylenediamine. Of these preferred amines, 2-aminoethanol and piperazine are most preferred.

Elastomer

The elastomeric component may be, a single elastomer, many different elastomers, mixtures of elastomers, elastomer containing compounds, di-block or tri-block copolymers containing elastomeric or soft segments, core-shell modifiers, combinations thereof or the like. In addition, the elastomer may be added as part of pre-reacted blend or compound. An example of this would be the product of reactively blending a chemically active or chemically functionalized elastomer with a chemically active or chemically functionalized resin or polymer. The adducting process results in a rubber adduct that may be used to provide the rubber component. In preferred embodiments, the rubber adduct includes up to about 60 % or more by weight of an elastomeric component. More preferably, the adduct includes between about 10% and 45% by weight elastomeric component and still more preferably between about 15% and 25% by weight elastomeric component.

Exemplary elastomers include, without limitation natural rubber, styrene-butadiene rubber, polyisoprene, polyisobutylene, polybutadiene, isoprene-butadiene copolymer, neoprene, butyl rubber, polysulfide elastomer, acrylic elastomer, ethylene acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, carboxyl-terminated butadiene, fluorinated hydrocarbons and the like. In one embodiment, recycled tire rubber is employed. According to one preferred embodiment, the elastomeric component is partially or substantially entirely composed of a nitrile rubber (e.g., a butyl nitrile). Nitrile rubber refers to a polymerization product of butadiene and acrylonitrile, and is commonly represented as NBR (Nitrile-Butadiene-Rubber). The co-polymer unit of NBR can be represented by the chemical formula:

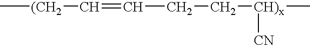

If such a nitrile rubber is employed, the rubber preferably includes between about 10% or less and about 50% or more by weight acrylonitrile, more preferably between about 20% and about 40% by weight acrylonitrile and even more preferably between about 25% and about 35% by weight acrylonitrile.

The elastomeric component is preferably composed at least partially or substantially entirely of a relatively low mooney viscosity elastomer. Preferably, the elastomeric component has a mooney viscosity of between about 10 or less and about 50 or greater, more preferably between about 15 and about 40 and even more preferably between about 22 and about 35 at a temperature of 100° C.. In a preferred embodiment, the elastomeric component includes one or more carboxyl groups (e.g., carboxylic acid groups) such as a carboxyl-terminated elastomer. The elastomeric component may also include pendant carboxy or carboxyl groups. In such an embodiment the elastomeric component preferably has a carboxyl content of between about 0.005 equivalents per hundred rubber (EPHR) or less and about 0.4 EPHR or greater, more preferably between about 0.01 EPHR and about 0.2 EPHR and even more preferably between about 0.05 EPHR and about 0.1 EPHR.

According to one preferred embodiment, the one or more elastomers includes an elastomer adduct, which may include any of the aforementioned elastomers chemically linked to another compound such as an epoxy resin. The elastomer adducts may be epoxy/carboxylated nitrile butadiene elastomer, epoxy/carboxylated ethylene methyl acrylate. Preferred epoxy/elastomer adducts are disclosed in U.S. Patent Application Publication 2004/0204551. One preferred exemplary adduct is a carboxyl terminated butadiene-acrylonitrile elastomer (CTBN)/epoxy adduct that is approximately 40% CTBN elastomer adducted with Bisphenol F based epoxy resin and is sold under the tradename EPON RESIN 58003 and is commercially available from Resolution Performance Products.

It has also been found block copolymers can additionally or alternatively be employed for toughening of the thermoplastic. As used herein, block copolymer can include one block copolymer or multiple different block copolymers, unless otherwise stated. It is contemplated that the one or more block copolymers may be reacted with (e.g., into) the chain of the thermoplastic, however, it has been found that such copolymers can provide a relatively high degree of toughening when they are blended with the thermoplastic material without reacting with the chain. Each block copolymer may be comprised of one or more of the following blocks: a styrene block, an acrylonitrile block, an elastomeric block, a butadiene block, an acrylate block, an acetate block, combinations thereof or the like.

When included, block copolymer will typically be at least about 4% or less, more typically at least about 8%, and even more typically at least about 14% by weight of the toughened thermoplastic material and will also typically be less than about 50% or more, more typically less than about 30% and even more typically less than about 22% of the toughened thermoplastic material. Moreover, when included, it is generally preferred, although not required, that the block copolymer be chemically compatible with the thermoplastic material such that the block copolymer distributes within the thermoplastic material substantially homogeneously for forming a substantially homogeneous toughened thermoplastic. Examples of preferred block copolymers include, without limitation, polystyrene-polybutadiene-polymethylmethacrylate (SBM), or polymethyl methacrylate-polybutyl acrylate-polymethyl methacrylate (MAM) and are sold under the tradename Nanostrength and are commercially available from Arkema. While it is generally preferred that such block copolymers include an elastomeric block, it is not absolutely required unless otherwise stated.

Other specialty types of block copolymer may be employed such as core-shell impact modifiers. Such modifiers can be dispersed in the thermoplastic material. If desired, these impact modifiers can be dispersed within the thermoplastic material as very small particles, having a primary dimension (e.g., a largest dimension of the particle) of about 50 to about 500 nanometers in diameter. Each particle is typically composed of an elastomeric core, which either may be crosslinked or not, and a thermoplastic shell. As an example, the elastomeric core may be comprised of, but not limited to, acrylic monomers such as butyl acrylate or a copolymer of butadiene and styrene. Also, as an example, the thermoplastic shell may be comprised of, but not limited to, polymethyl methacrylate, polymethyl methacrylate/polystyrene or polymethyl methacrylate copolymerized with other functionalized monomers. One preferred examples of an acrylic type core-shell impact modifiers that has a polymethyl methacrylate shell and an acrylic core is sold under the tradename Durastrength by Arkema. Another example is the MBS type having a polymethyl methacrylate/polystyrene shell and a polybutadiene/styrene core sold under the tradenames Durastrength by Arkema or Paraloid by Rohm and Haas.

Mixing and Formation

As suggested previously, formation of a modified thermoplastic according to the present invention involves the addition of a thermoplastic material to the one or more elastomers. This includes mixing the one or more elastomers with thermoplastic precursors or a thermoplastic material that is already formed and the mixing can include addition of the one or more elastomers to one or more precursors and/or the formed thermoplastic material, addition of the one or more precursors and or the formed thermoplastic material to the one or more elastomers or a combination thereof.

The ingredients may be intermixed in a batch process or in a series of different intermixing process such as heated reaction vessels with relatively high shear mixing. According to one embodiment, the modified thermoplastic is formed by feeding ingredients to an extruder (e.g., a single or twin screw extruder) or other mixing device.

The one or more elastomers may be simply compounded with the thermoplastic material without actual chemical reaction. Preferably, however, the one or more elastomers are chemically incorporated into the thermoplastic material to form a modified (e.g., toughened) thermoplastic material. As suggested, an elastomer may be reacted with the thermoplastic material such that the elastomer becomes part of a thermoplastic linear chain of the thermoplastic material, becomes a pendant group of the thermoplastic linear chain or end of the thermoplastic chain or any combination thereof.

Typically, the one or more elastomers are multifunctional and preferably difunctional for reacting with the thermoplastic material or precursors thereof, which are also multifunctional and preferably difunctional. As suggested above, particularly preferred thermoplastic materials are composed of epoxy and amine precursors and preferred elastomer include a functional group that will react with the epoxy, the amine or both. As an example, a difunctional carboxylated elastomer can include a carboxylic acid group at ends of the elastomer as show below:

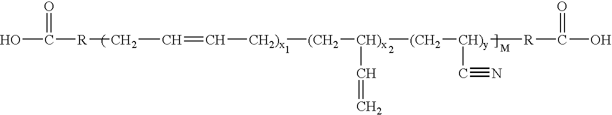

### This represents the chemical structure of Carboxyl Terminated Butadiene Acrylonitrile Elastomer (CTBN).

The chemical reaction of the functional end (carboxylic acid) of the CTBN elastomer with a polymer or thermoplastic or resin having a terminal epoxide group is shown below:

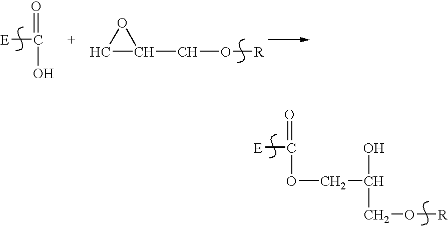

Advantageously, this carboxylic acid group can be reacted with an epoxy group of an epoxy resin as shown in scheme I above or can be reacted with an amine group of the amine as shown in scheme II below:

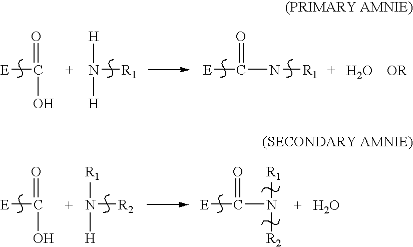

### EXAMPLE

A liquid epoxy resin (DER 331) was mixed with a pre-adducted carboxyl terminated butadiene-acrylonitrile elastomer (Epon Resin 58003) and monoethanolamine (MEA) to form a mixture. The mixture was 61.90 Wt. % DER 331; 25 wt. % Epon 58003; and 13.10 wt % MEA. The mixture reacted to form an elastomer toughened polyetheramine of the formula:

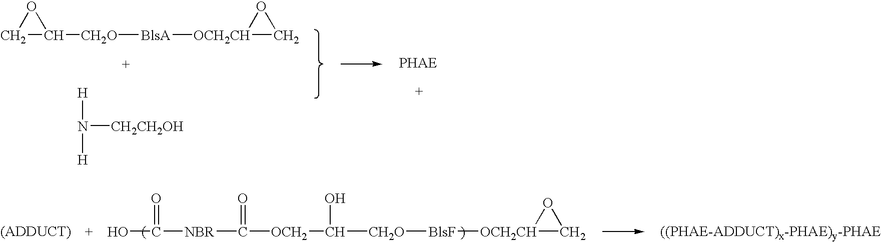

Here the adduct is composed of a primarily chemically difunctional Bisphenol F based liquid epoxy resin chemically reacted with a CTBN elastomer. This produces low molecular weight polymer chains that are either epoxy terminated, carboxylic acid terminated or both. Thus, the adduct is chemically difunctional. When this adduct is present during the PHAE reaction, the terminal chemical functionality of the adduct allows it to chemically react (incorporate) into the growing polymer chain.

In addition or as an alternative to the above toughening, it is contemplated that an original thermoplastic polymer may be toughened with one or more other toughening polymers (e.g., tougher thermoplastic, elastomer, both or the like), which can be reacted or grafted onto the original thermoplastic. Examples of suitable original thermoplastic polymers that can be toughened include, without limitation, reactive or functionalized thermoplastic epoxy resins (e.g., PHAE), amine/epoxy resins, hydroxyl containing epoxy resins, combinations thereof or the like, which include reactive or functional groups such as hydroxyl groups, epoxy groups, amine groups, combinations thereof or the like. Toughening polymers will typically have certain desirable properties or will provide desirable properties to the original thermoplastic (e.g., the TPER) such as higher ductility, higher impact strength, higher elongation at break or the like. Polymers suitable for such toughening include tougher thermoplastics, elastomers, thermoplastic elastomers or combinations thereof, which include (e.g., have been modified to include) chemical functional groups such as carboxylic acids, anhydrides (e.g., maleic anhydrides, glycidyl or epoxy group, combinations thereof or the like that are reactive with functional groups of the original thermoplastic such as hydroxyl groups, epoxy groups, amine groups, combinations thereof or the like. Examples of polymers that can be modified to include such chemical functional groups include, without limitation, tougher thermoplastics such as polyolefin (e.g., polyethylene), ethylene containing polymer, polyester, polyacrylate, polyacetate, thermoplastic polyolefin (e.g., ethylene methacrylate (EMA), ethylene vinyl acetate (EVA) or both), combinations thereof or the like and/or elasomer such as polyisoprene, polybutadiene or both.

In one preferred embodiment, a thermoplastic epoxy resin (e.g., PHAE) in accordance with the previous description of thermoplastic epoxy resins is toughened with a toughening polymer such as thermoplastic acetate (EVA), thermoplastic acrylate (EMA) or both by mixing and/chemically reacting the reactive or functional TPER described above with the toughening polymer where the toughening polymer is functionalized with one or more amine, hydroxyl and/or epoxy reactive groups such as epoxide groups, carboxylic acid groups, maleic acid groups, anhydride groups, combinations thereof or the like. One example of such a functionalized toughening polymer (e.g., a relatively tougher thermoplastic) that is a glycidyl methacrylate modified ethylene methacrylate polymer (e.g., copolymer or terpolymer) sold under the tradename LOTADER AX8950, commercially available from Arkema Chemicals. Another example of such a functionalized toughening polymer (e.g., a relatively tougher thermoplastic) is a maleic anhydride modified ethylene vinyl acetate sold under the tradename FUSABOND MC 190D or MC 250D, both commercially available from DuPont. Yet another example of a functionalized toughening polymer (e.g., an elastomer, thermoplastic or combination thereof) is an ethylene butyl acrylate modified with maleic anhydride sold under the tradename LOTADER 3410, also commercially available from Arkema Chemicals.

It shall be understood that such toughening polymer can be reacted with or into (e.g., grafted onto) the original thermoplastic chain according to any of the schemes discussed with relation to the elastomer. Thus, the toughening polymer can be reacted into the original thermoplastic chain itself, can be pendant relative to the original thermoplastic chain, can be the end of the original chain or any other of the combinations discussed above. Such location of the toughening polymer will typically depend upon the location of the reactive group (e.g., amine or hydroxyl groups) of the original thermoplastic (e.g., TPER), the location of the reactive groups (e.g., epoxide groups, anhydride groups or both) on the tougher thermoplastic (e.g., EVA, EMA or combination thereof) or both. Thus, the toughened thermoplastic is an original thermoplastic/tougher thermoplastic adduct or reaction product (e.g., a TPER/Polyolefin polymer (e.g., copolymer, terpolymer or both)). Examples includes TPER/EVA (e.g., PHAE/EVA) copolymer and TPER/EMA (e.g., PHAE/EMA) copolymer.

The original thermoplastic and the toughening polymer may be mixed and/or reacted according to a variety of protocols depending upon the end use for the toughened thermoplastic. According to a preferred embodiment, the original thermoplastic is melt mixed in an extruder (e.g., a 25 mm twin screw extruder) or batch mixer with the tougher thermoplastic to react the thermoplastics as described. The desired temperature for this mixing can vary depending upon the thermoplastics and/or polymers to be mixed and reacted, but are typically above the T_{g} of the TPER, above the Tₘ of the toughening polymer or both. Non-limiting examples of typical temperatures are between about 200° F. and about 500° F., more typically between about 300° F. and about 420° F. and still more typically between about 340° F. and about 400° F.. Toughening in this manner allows intermixing and reacting of the original thermoplastic and the toughening polymer (e.g., tougher thermoplastic) wherein one or both of the original thermoplastic and the toughening polymer are solids at room temperature (23° C.) and their reaction product is also a solid at room temperature. Such solids can be provided as masses (e.g., pellets, chunks or the like) that can be convenient for formation, processing or the like.

Advantageously, toughening the original thermoplastic in this manner allows for toughening with toughening polymer (e.g., tougher thermoplastic or elastomer) that may, under normal circumstances, be relatively incompatible with the original thermoplastic. For example, TPER, which is typically relatively polar, may be reacted with polyolefin (e.g., EMA or EVA), which is, in comparison to the TPER typically relatively non-polar as determined by solubility parameters. Thus it is contemplated that the original thermoplastic (e.g., TPER or PHAE), before or after being functionalized, can have a solubility parameter (e.g., a Hildebrand solubility parameter) that is at least 1.7 MPa^{1/2}, more typically at least 2.0 MPa^{1/2} and even possibly at least 3.0 MPa^{1/2} different (i.e., higher or lower) than the toughening polymer before or after that toughening polymer has been functionalized. The solubility parameters of numerous polymers are available in standard tables, can be calculated by group contribution methods or can be obtained by performing a series of solubility tests in various solvents with known solubility parameters. Alternatively, the miscibility of two polymers can be tested by casting a film of the two polymers from a mutual solvent, and subjecting the film to microscopic inspection or thermal analysis.

As an added advantage, the toughened thermoplastic is often more compatible with further additional polymer (e.g., thermoplastic) that are the same, similar to or at least compatible with the original thermoplastic, the tougher thermoplastic or both even where that additional polymer is without functional groups for reacting with either the original thermoplastic or the tougher thermoplastic. Overcoming these significant incompatibilities and promoting compatibility can allow for the creation of toughened thermoplastic with desirable properties (e.g., desirable toughness, strength modulus or the like) in situations where the incompatibilities might otherwise degrade or cause undesirable properties.

Advantageously, modification or toughening of the thermoplastics as described herein can significantly raise the impact strength thereof when such impact is determined in accordance with notched izod impact strength testing according to ASTM D256-04. For examples a toughened TPER (e.g., PHAE) can have an impact strength that is at least 1.5×, (1.5 times) more typically at least 3×, even more typically at least 10×, and possibly at least 10× or even at least 900× relative to the original unmodified TPER or neat TPER. For example, toughened TPER (e.g., PHAE) according to the present invention can have a notched izod impact strength of at least 10× or at least 100 Joules/Meter when measured relative to the original unmodified or neat TPER (e.g., PHAE) from which it was made and which has a notched izod impact strength of 10 Joules/Meter. Desired notched izod impact strength for any of the toughened material discussed herein is typically at least about 20 Joules/meter, more typically at least about 30 Joules meter, possibly at least 50 Joules/meter and even possibly at least 100 Joules/meter.

Applications, Processing and other Materials

The modified thermoplastic material of the present invention may be used by itself in various applications and may be an ingredient of other compositions. Moreover, the modified thermoplastic material or compositions including the material can be formed into fibers, films, sheets, foamable materials, molded parts, combinations thereof or the like. Moreover, formation or shaping of the thermoplastic material may be accomplished using any known thermoplastic shaping techniques such as injection molding, blow molding, compression molding, extrusion, cast film, blown film and combinations thereof or the like.

As one particular example, it is contemplated that the material could be used as an ingredient in powder coating formulations for various structures of articles of manufacture (e.g., engines, automotive vehicles, trains, boats, bicycles, appliances, industrial equipment or the like). Accordingly, the thermoplastic material may be formed into a powder and applied (e.g., via a spray nozzle) to a surface of a structure. The powder may be electrically charged according to various powder coating techniques for assisting the powder in at least temporarily attaching itself to the structure. Thereafter, the powder is typically baked onto the structure.

In another embodiment, it is contemplated that the modified thermoplastic could be incorporated into an activatable (e.g., curable, thermosettable, expandable or foamable) material. For example, the toughened or modified thermoplastic could be employed as an impact modifier or self support agent for a thermosetting composition. In such a material, the modified thermoplastic would be incorporated with a combination of one or more of the following ingredients: blowing agent; blowing agent accelerator; curing agent; curing agent accelerator; additional polymeric materials (e.g., thermosettable polymers), fillers, other additives or the like. Such activatable materials are typically activated to cure, expand (e.g., foam), whet, adhere or any combination thereof to a substrate by exposure of the material to a condition and/or by chemical reaction. Exemplary conditions include heat, moisture, pressure, radiation, combinations thereof or the like.

Such activatable material can be used for providing various functional attributes such as baffling, dampening, reinforcement, sealing, combinations thereof or the like to structures (e.g., pillars) of articles of manufacture (e.g., automotive vehicles). Generally such activatable material may be applied directly to structures of the article of manufacture or may be applied to carriers and subsequently applied to the structures. U.S. patent application Ser. No. 10/430,993, filed May 7, 2003 and incorporated herein by reference for all purposes, discusses incorporation of a thermoplastic polyether into an activatable material and discusses uses for that activatable material. In the same manner, the modified thermoplastic of the present invention can be incorporated into an activatable material and be employed in the same uses.

It is also contemplated that the toughened thermoplastic material may be used to form numerous articles of manufacture such as vehicle bumpers, toughened films, powder coatings, adhesive films, toughened electrically conductive films, paint films, barrier films, or the like. The toughened thermoplastic can also be employed as a matrix material for fibrous composite materials, which can be continuously or otherwise formed composites. Moreover, the toughened thermoplastic could be employed as a stand alone or as part of a formulation for a hot melt adhesive, which may be a curable or non-curable adhesive (e.g., for a joint such as a hem flange).

Preferably, the thermoplastic material once formed and/or processed or used will be substantially free of any cross-linking, thermosetting or both, although not required unless otherwise stated. As used herein, substantially free of any cross-linking, thermosetting or both means that greater than 85%, more typically greater than 95% and even more typically greater than 99% of the continuous polymeric chains of the thermoplastic material are cross-linked directly to less than four, more typically less than 2 and even more typically less than 1 other continuous polymeric chains of the material. Thus, it has been found that preferred embodiments of the material can be melted, processed, shaped, solidified or a combination thereof multiple repeated times while typically retaining or returning to their original chemical configurations as they were in an original melted or solid state.

### EXAMPLES

The materials of each of the examples has been either blended or reactively extruded on a 44:1 L/D co-rotating, intermeshing twin screw extruder at temperatures of approximately 200° C. and rates of about 20 to 30 lb/hr. Once produced, melt flow rate was measured by ASTM test method ASTM D 1238-01 to determine flow behavior. In addition, the test samples were injection molded into ASTM D 638-02 Type I tensile bars for tensile testing and flexural testing (ASTM D 790). Finally, notched izod impact specimens were cut from tensile bars and the room temperature impact energy measured according to ASTM D 256-04.

Examples 1 through 4 involve toughening TPER by reactively blending a toughener with TPER. Examples 5 and 6 involve toughening TPER by blending (non-reactively) toughening copolymers. Example 7 involves toughening TPER by copolymerizing TPER reactants with a chemically reactive rubber/adduct.

### Example 1

In the first example, the TPER is reactively blended with a maleic anhydride containing ethylene-butyl acrylate (EBA) terpolymer. The EBA-maleic anhydride terpolymer, Lotader 3410 from Arkema Inc. (Philadelphia, Pa.), is reactively extruded with a 120 MI (190C/2.19 kg) TPER on a twin screw extruder at weight fractions of 30 and 40%. The resulting polymers are injection molded into tensile bars and tested. Table I shows a property comparison between the base TPER and the material reactively modified with Lotader 3410. The reductions in the moduli and increase in strain with increased terpolymer loading show a general flexibilizing of the TPER. In addition, the marked improvement of impact energy further highlights the toughening effects of the reactive blend.

TABLE I

| | | | | | |
|---|---|---|---|---|---|
| | TPER | % | 100 | 70 | 60 |
| | Lotader | | | | |
| | 3410 | % | 0 | 30 | 40 |
| | MI | | | 0.68 | 0.15 |
| | (190/2.16) | dg/min | 123.2 | (190 C./ | (190 C./ |
| | | | | 4.86 kg) | 4.86 kg) |
| Tensile | Modulus | MPa | 3031 | 1400 | 1058 |
| | Yield Stress | MPa | 26 | 29.7 | 22.9 |
| | Yield Strain | % | 0.9 | 5.2 | 6.3 |
| | Break | | | | |
| | Stress | MPa | 26.6 | no break | no break |
| | Break Strain | % | 0.9 | no break | no break |
| | Break | | 5/5 | 0/5 | 0/5 |
| Flexural | Strength | MPa | 88.6 | 42.1 | 32.8 |
| | Modulus | MPa | 2860 | 1324 | 1022 |

| | | | | |
|---|---|---|---|---|
| Notched Izod Impact | J/m | 12.1 | 159.4 | 593.7 |

### Example 2

In the second example, the TPER is reactively blended with a maleic anhydride modified ethylene-vinyl acetate (EVA) copolymer. The EVA-maleic anhydride copolymer, Fusabond C MC190D (DuPont, Wilmington, Del.), is reactively extruded with a 120 MI (190C/2.19 kg) TPER on a twin screw extruder at weight fractions of 20, 30 and 40%. The resulting polymers are injection molded into tensile bars and tested. Table II shows a property comparison between the base TPER and the material reactively modified with Fusabond C MC190D. The reductions in the moduli and increase in strain with increased corpolymer loading show a general flexibilizing of the TPER. In addition, the marked improvement of impact energy further highlights the toughening effects of the reactive blend.

TABLE II

| | | | | | | |
|---|---|---|---|---|---|---|
| | TPER | % | 100 | 80 | 70 | 60 |
| | Fusabond C | | | | | |
| | MC 190D | % | 0 | 20 | 30 | 40 |
| | MI | | | | | 2.2 |
| | (190/2.16) | dg/min | 123.2 | 32.8 | 2.7 | (190 C./ |
| | | | | | | 4.86 kg) |
| Tensile | Modulus | MPa | 3031 | 1854 | 1477 | 1139 |
| | Yield Stress | MPa | 26 | 37.3 | 30.1 | 22.2 |
| | Yield Strain | % | 0.9 | 3.8 | 4.4 | 4.7 |
| | Break | | | | | |
| | Stress | MPa | 26.6 | 33.0 | NA | 19.8 |
| | Break Strain | % | 0.9 | 21.3 | NA | 49.6 |
| | Break | | 5/5 | 5/5 | 0/5 | 1/5 |
| Flexural | Strength | MPa | 88.6 | 55.3 | 42.7 | 31.6 |
| | Modulus | MPa | 2860 | 1813.2 | 1404.9 | 1012.0 |

| | | | | | |
|---|---|---|---|---|---|
| Notched Izod Impact | J/m | 12.1 | 30.0 | 60.8 | 156.9 |

### Example 3

In the third example, TPER is reactively blended with a maleic anhydride modified cis-1,4-polybutadiene homopolymer. The 1,4-PB-maleic anhydride polymer, Polyvest EP OC 1200 S (Degussa Corp., Parsippany, N.J.), is reactively extruded with a 120 MI (190C/2.19 kg) TPER on a twin screw extruder at weight fractions of 5, 10, 15 and 20%. The resulting polymers are injection molded into tensile bars and tested. Table III shows a property comparison between the base TPER and the material reactively modified with Polyvest EP OC 1200 S. The reductions in the moduli and increase in strain with increased copolymer loading show a general flexibilizing of the TPER. In addition, the improvement of impact energy further highlights the toughening effects of the reactive blend.

TABLE III

| | | | | | | | |
|---|---|---|---|---|---|---|---|
| | TPER | % | 100 | 95 | 90 | 85 | 80 |
| | Polyvest EP | | | | | | |
| | OC 1200 S | % | 0 | 5 | 10 | 15 | 20 |
| | MI | | | | | | |
| | (190/2.16) | dg/min | 123.2 | 7.6 | 0.32 | 0.06 | NA |
| Tensile | Modulus | MPa | 3031 | 2651 | 2178 | 1815 | 1645 |
| | Yield Stress | MPa | 26 | 40.9 | 43.6 | 41.7 | 37.5 |
| | Yield Strain | % | 0.9 | 2.0 | 5.2 | 7.5 | 11.0 |
| | Break | | | | | | |
| | Stress | MPa | 26.6 | 40.9 | 39.1 | 39.7 | 36.6 |
| | Break Strain | % | 0.9 | 2.0 | 15.3 | 15.4 | 24.4 |
| | Break | | 5/5 | 5/5 | 5/5 | 5/5 | 5/5 |
| Flexural | Strength | MPa | 88.6 | 81.4 | 73.1 | 64.0 | 52.0 |
| | Modulus | MPa | 2860 | 2325 | 2054 | 1834 | 1464 |

| | | | | | | |
|---|---|---|---|---|---|---|
| Notched Izod Impact | J/m | 12.1 | 17.5 | 21.4 | 26.0 | 25.7 |

### Example 4

In the fourth example, TPER is reactively blended with an epoxidized ethylene-methyl acrylate (EMA)-glycidyl methacrylate terpolymer. The EMA-glycidyl methacrylate terpolymer, Lotader AX 8910 from Arkema Inc. (Philadelphia, Pa.), is reactively extruded with a 120 MI (190C/2.19 kg) TPER on a twin screw extruder at weight fractions of 10, 20, and 35%. The resulting polymers are injection molded into tensile bars and tested. Table IV shows a property comparison between the base TPER and the material reactively modified with Lotader AX 8910. The reductions in the moduli and increase in strain with increased terpolymer loading show a general flexibilizing of the TPER. In addition, the improvement of impact energy further highlights the toughening effects of the reactive blend.

TABLE IV

| | | | | | | |
|---|---|---|---|---|---|---|
| | TPER | % | 100 | 90 | 80 | 65 |
| | Lotader AX | | | | | |
| | 8950 | % | 0 | 10 | 20 | 35 |
| | MI (190/2.16) | dg/min | 123.2 | 82.6 | 57.0 | 40.1 |
| Tensile | Modulus | MPa | 3031 | 2461 | 2016 | 1259 |
| | Yield Stress | MPa | 26 | 51.4 | 42.3 | 24.8 |
| | Yield Strain | % | 0.9 | 4.3 | 4.2 | 5.4 |
| | Break Stress | MPa | 26.6 | 37.1 | 30.3 | 23.7 |
| | Break Strain | % | 0.9 | 22.6 | 34.3 | 12.9 |
| | Break | | 5/5 | 5/5 | 5/5 | 5/5 |
| Flexural | Strength | MPa | 88.6 | 76.6 | 62.1 | 31.9 |
| | Modulus | MPa | 2860 | 2375 | 2005 | 1070 |

| | | | | | |
|---|---|---|---|---|---|
| Notched Izod Impact | J/m | 12.1 | 17.9 | 34.1 | 90.6 |

### Example 5

In the fifth example, TPER is non-reactively blended with a methylmethacrylate-butadiene-styrene block (MBS) terpolymer. The MBS block teprolymer, Nanostrength SBM E-20 from Arkema Inc. (Philadelphia, Pa,), is blended with a 120 MI (190C/2.19 kg) TPER on a twin screw extruder at weight fractions of 10, 20, and 30%. The resulting polymers are injection molded into tensile bars and tested. Table V shows a property comparison between the base TPER and the material modified with Nanostrength SBM E-20. The reductions in the moduli and increase in strain with increased terpolymer loading show a general flexibilizing of the TPER. In addition, the improvement of impact energy further highlights the toughening effects of the blend.

TABLE V

| | | | | | | |
|---|---|---|---|---|---|---|
| | TPER | % | 100 | 90 | 80 | 70 |
| | Nanostrength | | | | | |
| | SBM E20 | % | 0 | 10 | 20 | 30 |
| | MI (190/2.16) | dg/min | 123.2 | 75.7 | 48.2 | 28.5 |
| Tensile | Modulus | MPa | 3031 | 2650 | 2170 | 1836 |
| | Yield Stress | MPa | 26 | 39 | 46 | 38 |
| | Yield Strain | % | 0.9 | 1.7 | 4.1 | 4.5 |
| | Break Stress | MPa | 26.6 | 38.7 | 38.8 | 28.0 |
| | Break Strain | % | 0.9 | 1.7 | 11.8 | 23.4 |
| | Break | | 5/5 | 5/5 | 5/5 | 5/5 |
| Flexural | Strength | MPa | 88.6 | 84.6 | 69.3 | 58.1 |
| | Modulus | MPa | 2860 | 2524 | 2121 | 1862 |

| | | | | | |
|---|---|---|---|---|---|
| Notched Izod Impact | J/m | 12.1 | 11.7 | 14.8 | 23.7 |

### Example 6

In the sixth example, a non-reactive blend of the TPER with a methylmethacrylate-butadiene-styrene block (MBS) core-shell polymer is constructed and tested. The MBS core-shell polymer, Paraloid EXL-2691A from Rohm and Haas Co. (Philadelphia, Pa.), is blended with a 120 MI (190C/2.19 kg) TPER on a twin screw extruder at weight fractions of 10, 20, and 30%. The resulting polymers are injection molded into tensile bars and tested. Table VI shows a property comparison between the base TPER and the material modified with Paraloid EXL-2691A. The reductions in the moduli and increase in strain with increased terpolymer loading show a general flexibilizing of the TPER. In addition, the improvement of impact energy further highlights the toughening effects of the blend.

TABLE VI

| | | | | | | |
|---|---|---|---|---|---|---|
| | TPER | % | 100 | 90 | 80 | 70 |
| | Paraloid | | | | | |
| | EXL 2691A | % | 0 | 10 | 20 | 30 |
| | MI | | | | | |
| | (190/2.16) | dg/min | 123.2 | 45.8 | 27.6 | 2.0 |
| Tensile | Modulus | MPa | 3031 | 2487 | 2285 | 1745 |
| | Yield Stress | MPa | 26 | 51 | 47 | 36 |
| | Yield Strain | % | 0.9 | 4.0 | 4.2 | 4.3 |
| | Break | | | | | |
| | Stress | MPa | 26.6 | 51.5 | 36.6 | 29.3 |
| | Break Strain | % | 0.9 | 4.0 | 16.5 | 28.9 |
| | Break | | 5/5 | 5/5 | 5/5 | 5/5 |
| Flexural | Strength | MPa | 88.6 | 76.0 | 69.4 | 54.4 |
| | Modulus | MPa | 2860 | 2289 | 2075 | 1651 |

| | | | | | |
|---|---|---|---|---|---|
| Notched Izod Impact | J/m | 12.1 | 12.0 | 12.0 | 36.8 |

### Example 7

In the seventh example a liquid bisphenol-A based epoxy resin (DER 331 from Dow Chemical, Midland, Mich.) is co-polymerized with an adduct of 40% carboxy-terminated butadiene-acrylonitrile (CTBN) rubber in a Bisphenol F based liquid epoxy resin (Epon Resin 58003, Hexion Specialty Chemicals, Houston, Tex.) and a small amount of monoethanolamine amine (MEA). This example illustrates one possible avenue of building toughness into the TPER molecular backbone by polymerizing an elastomer, or elastomer containing material, with the TPER reactants. In this manner, the rubber toughening agent is polymerized directly into the TPER polymer. The material of this example was polymerized to give an overall CTBN content of 10% and done with the varying liquid epoxy resin to MEA ratios to control the degree of polymerization. The degree of polymerization scales inversely with the melt flow ratio. As with the prior examples, the resulting polymers were injection molded into tensile bars and tested. In this example, however, the tensile bars are designed to the ISO recommended shape defined by ISO R 527. Table VII shows a property comparison between different molecular weights of TPER copolymerized with Epon Resin 58003 and MEA such that the CTBN level is at 10%.

TABLE VII

| pellet | | | | | |
|---|---|---|---|---|---|
| MFR | tensile bar | Tensile | Tensile | | |
| (190 C./ | MFR | break | break | Tensile | Notched |
| 2.16 kg) | (190 C./2.16 kg) | stress | strain | modulus | Izod |
| dg/min | dg/min | MPa | % | MPa | J/m |
| 1.6 | 1.3 | 32.3 | 19.0 | 2474 | 54.8 |
| 9.6 | 8.2 | 30.9 | 23.0 | 2501 | 38.9 |
| 20.4 | 19.2 | 30.3 | 21.0 | 2713 | 10.9 |
| 25.6 | 26.3 | 39.8 | 8.0 | 2639 | 18.3 |
| 27.4 | 29.6 | 35.9 | 11.0 | 2576 | 9.8 |
| 47.6 | 41.0 | 43.0 | 6.0 | 2281 | 9.5 |

Unless stated otherwise, dimensions and geometries of the various materials discussed herein are not intended to be restrictive of the invention, and other materials are possible. In addition, while a feature of the present invention may have been described in the context of only one of the illustrated embodiments, such feature may be combined with one or more other features of other embodiments, for any given application. It will also be appreciated from the above that the fabrication of the unique materials herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A toughened polymeric material, comprising:
a thermoplastic material formed of polymeric chains wherein the thermoplastic material includes a polyetheramine; and
at least one toughener toughening the thermoplastic material, the at least one toughener selected from a tougher thermoplastic polymer, an elastomer or a combination thereof, wherein either:
i. the at least one toughener is grafted onto ends of the polymeric chains;
ii. the at least one toughener is disposed along the polymeric chains as pendant group or within the polymeric chains; or
iii. the at least one toughener is non-reactively blended with the polymer chains.

2. A polymeric material as in claim 1 wherein the at least one toughener includes an elastomer that is incorporated within the polymeric chains.

3. A polymeric material as in claim 1 wherein the at least one toughener includes an elastomer that is a pendant group of the polymeric chains of the thermoplastic material.

4. A polymeric material as in claim 1 wherein the polymeric material is part of a powder coating covering the surface of a substrate.

5. A polymeric material as in claim 1 further comprising a curing agent, a blowing agent or both, the polymeric material being activatable to expand, cure or both and adhere to a structure.

6. A polymeric material as in claim 1 wherein the polymeric material is formed by reactively blending the at least one toughener with the thermoplastic material wherein the at least one toughener includes an elastomer that is epoxidized or includes maleic anhydride.

7. A polymeric material as in claim 1 wherein the thermoplastic material, once toughened, exhibits an impact strength that is at least 3× relative to thermoplastic material prior to toughening.

8. A polymeric material as in claim 1 wherein the thermoplastic material, once toughened, exhibits a notched izod impact strength of at least about 20 Joules/meter.

9. A polymeric material as in claim 1 wherein the thermoplastic material, once toughened, exhibits a notched izod impact strength of at least about 50 Joules/meter.

10. A toughened polymeric material, comprising:
a thermoplastic material formed of polymeric chains wherein the thermoplastic material includes a polyetheramine; and
at least one toughener toughening the thermoplastic material, the at least one toughener selected from a tougher thermoplastic polymer, an elastomer or a combination thereof, the at least one toughener including a butyl group or an ethylene group, wherein either:
i. the at least one toughener is grafted onto ends of the polymeric chains; or
ii. the at least one toughener is disposed along the polymeric chains as pendant group or within the polymeric chains.

11. A polymeric material as in claim 10 wherein the at least one toughener includes an epoxy/elastomer adduct that is incorporated within the polymeric chains.

12. A polymeric material as in claim 10 wherein the at least one toughener includes an elastomer that is a pendant group of the polymeric chains of the thermoplastic material.

13. A polymeric material as in claim 10 wherein the polymeric material is part of a powder coating covering the surface of a substrate.

14. A polymeric material as in claim 10 further comprising a curing agent, a blowing agent or both, the polymeric material being activatable to expand, cure or both and adhere to a structure.

15. A polymeric material as in claim 10 wherein the polymeric material is formed by reactively blending the at least one toughener with the thermoplastic material wherein the at least one toughener includes an elastomer that is epoxidized or includes maleic anhydride.

16. A polymeric material as in claim 1 wherein the thermoplastic material, once toughened, exhibits an impact strength that is at least 10× relative to thermoplastic material prior to toughening.

17. A polymeric material as in claim 1 wherein the thermoplastic material, once toughened, exhibits a notched izod impact strength of at least about 50 Joules/meter.

18. A toughened polymeric material, comprising:
a thermoplastic material formed of polymeric chains wherein the thermoplastic material includes a polyetheramine; and
at least one toughener toughening the thermoplastic material, the at least one toughener that includes an elastomer, the at least one toughener including a butyl group or an ethylene group, wherein either:
i. the at least one toughener is grafted onto ends of the polymeric chains; or
ii. the at least one toughener is disposed along the polymeric chains as pendant group or within the polymeric chains; and
wherein:
i. the elastomer has a relatively low mooney viscosity that is between about 10 and about 50;
ii. the polymeric material exhibits a notched izod impact strength of at least 50 Joules/meter.

19. A polymeric material as in claim 28 wherein the thermoplastic material, once toughened, exhibits an impact strength that is at least 10× relative to thermoplastic material prior to toughening.

20. A polymeric material as in claim 19 wherein the at least one tougher include an acetate, an acrylate or a butyl rubber.
